(19) United States
(12) Patent Application Publication
(10) Pub. No.: US 2005/0202389 A1
(43) Pub. Date: Sep. 15, 2005

(54) Collaborative e - learning activity structures

(76) Inventor: Michaela Ronen, Pardes Hanna (IL)

Correspondence Address: WELSH & FLAXMAN LLC, 2450 CRYSTAL DRIVE, SUITE 112, ARLINGTON, VA, 22202, US

(21) Appl. No.: 11/075,796

(22) Filed: Mar. 10, 2005

Related U.S. Application Data
(60) Provisional application No. 60/552,735, filed on Mar. 15, 2004.

(51) Int. Cl. G09B 3/00

(52) U.S. Cl. 434/350; 434/362

(57) ABSTRACT

A method for creating structured e-learning activities. A tutor using authoring tools for issuing structures implemented in stages. Participants collaborate in a succession of stages employing respective graphic user interfaces, wherein each stage includes at least a presentation object, or an input object or an interaction object or a communication object. The inputs of the participants are kept in a database for subsequent presentation.

### FIELD OF THE INVENTION

The present invention is in the field of e-learning. More specifically the invention is a system for integrating contributions from distant learners.

### BACKGROUND OF THE INVENTION

As opposed to passive learning, an active learning process implicates active participation on behalf of the learner. The active part is played by the learner in active learning such as by contributing to an open discussion or asking a question and investigating actively as to the subject on the agenda. Hereinafter throughout the description, the noun “activity” will refer to any set of actions taken by an e-learner which implies direct or indirect interaction with other learners or teachers/instructors.

Collaborative learning is a form of learning in which the goals are achieved by implementing collaborative activities between the learners themselves, in addition to the interaction with the teacher/instructor. The teaching and learning in a collaborative environment must be managed, and just like in a game, rules are openly divulged and must be obeyed.

The present invention aims at providing standardization to the structure of collaborative learning activities in order to enable sharing and reuse of collaborative pedagogical strategies implemented via the Internet.

### SUMMARY OF THE INVENTION

In accordance with the present invention, an activity author uses an authoring tool for producing, or for changing and adapting an activity structure format. The learning activity of the invention is conducted in stages, each of which stage is attended to by a participant or a group thereof, without necessarily being aware of the activities of the other participants. Activity structure objects are participant interface components that convey information and instructions to the participants and allow different kinds of interactions to take place. The learning activity is regulated by the activity structure objects which are are: presentation, input, interaction and communication.

The database of the system is used to store and manipulate data received in one or more activity structure stages. The one or more authors have access to the system database.

### BRIEF DESCRIPTION OF THE DRAWINGS

FIG. 1 is a schematic description of the succession of stages receiving activities from the author;

FIG. 2 is a schematic description of the relationships between the author, learner and the activity structure.

### DESCRIPTION OF THE PRESENT INVENTION

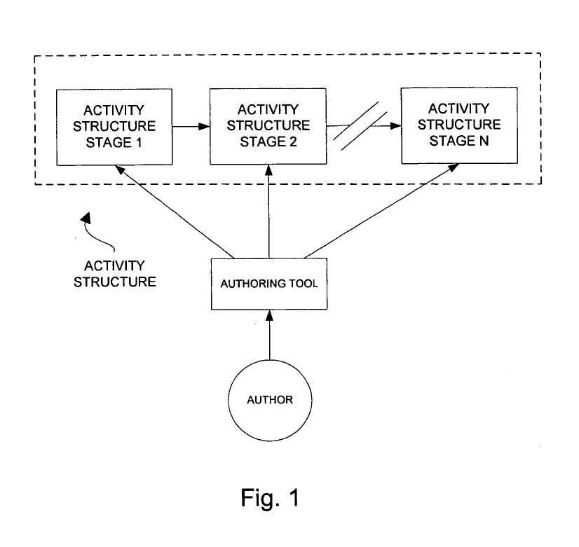

The present invention is implemented within the framework of collaborative activities carried out by e-learning means. The structured activity of the invention is intended to formulate a standardized mechanism for streamlining collaborative learning activities. In a framework of the e-learning activity of the invention, an activity author (AU) is a person who formulates and issues the structured activities. Another aspect of the authorship is in adaptation of the structure of the activities to the characteristics of the various stages of the learning activity. The learning activity in which the present invention is implemented is an asynchronous one, relating to the fact that the collaborating participants attend each stage of the learning activity over a time period during which they may not be aware of the activities of the other participants. The terms participant or student or learner in the present description relate to the studying party participating actively in the learning activity. Participation is effected through an interface, which is typically personalized, adapted to the role of each participating end. In FIG. 1 to which reference is now made, an e-learning activity structure, referred to hereinafter as AS (activity structure), is described schematically, as constructed forming a sequence of stages, each such stage referred to as ASS (activity structure stage). ASS₁ is issued by the author (AU) who uses an authoring tool for that matter. ASS₂ is typically different than the ASS₁ and ASSₙ is typically different than the other ASSs of the learning activity. Each such stage is issued by the AU to best suit the particular task of the specific participant within the framework of the specific stage. Examples of ASs in the context of this invention are: creating a common database, grading, sorting classifying, editing, categorizing, analyzing a common database, debate, reaching an understanding, peer evaluation, peer product assessment and grading, role play, creating a common product and contest.

The AS (Activity Structure) and the Associated ASS (Activity Structure Stage) Formats

The format of an ASS typically incorporates four basic types of objects, hereinafter referred to as ASS objects, which regulate the learning activity. These ASS objects are: presentation, input, interaction and communication, further described below. ASS objects are interface components that convey information and instructions to the participants and allow different kinds of interaction.

Presentation objects are passive components that convey background and instructions as media of any kind (text, sound, graphics or video).

Input objects are interfaces that allow the participant to submit new data to the system (as voting on a given scale, text, hyperlinks, media or any kind of attached electronic file).

Interaction objects are interfaces that allow the participants to change, reorganize or respond to data that exists in the system (by grading, ranking, categorizing or evaluating it or by editing and changing previously submitted items) via text or graphic manipulations.

Communication objects are interfaces that allow participants to freely communicate with each other.

Each type of object is defined structurally and functionally within certain limits of freedom by the AU via the author interface, so that it reflects the goals of the specified ASS and AS. Accordingly, The AU can control the general properties of an ASS. For example, the AU decides as regards the start and end time, opts weather to disclose or reveal prior contributions through input objects, decides as regards the anonymity of contributors and decide whether generic announcements are to be issued upon the completion of an ASS

Authoring Tool and Interfaces

As described above, the AU uses an authoring tool for producing, or for changing and adapting an AS format. The AU governs the structure of the GUI (graphic user interface) that the participants use, and also the functionality of the ASS objects to the specific needs of the learning activity or stage within the learning activity. The authoring tool, through the authoring interface, enables the author to impose specific differential functioning either personalized or related to group, on the student interface at each stage of the activity, such as the inclusion of different elements in learners respective interface, or attributing different contents stored in the database to the same elements for different participants. The system of the invention provides a bank of AS and ASS templates for the AU to select from for each stage and retrieve for use. The AU may adapt the existing templates for a specific task or stage.

System Database

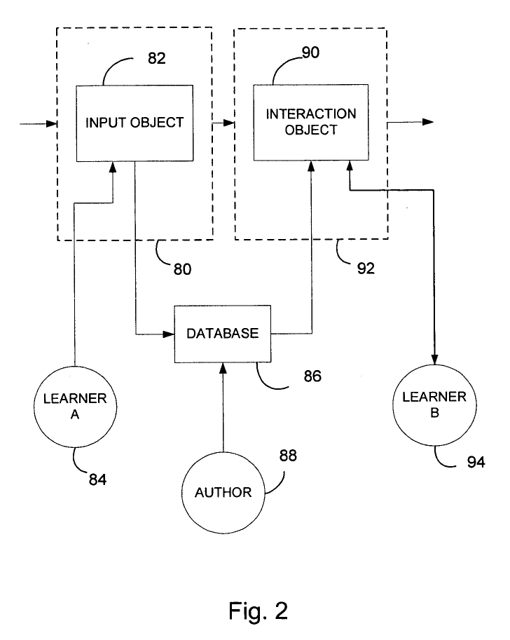

The database of the system is used to store and manipulate data received in one or more ASSs. An example of the function of the database is explained with reference to FIG. 2. In ASS 80 the input object 82 is used to accept data from a participant 84. Database 86 receives the data and stores it in a format suitable for inspection by the AU 88. The data in the database is assessed by the AU who may choose to manipulate it before it is sent to the interaction object 90 of the ASS 92. Participant 94 relates to the data presented in interaction object 90 by actively manipulating it. In the same ASS, more than one participant may contribute by using the interface.

Participant Association and Identification

In the system of the invention, a participant typically has a unique identity, and once registered, the AU and other participants may address that identity directly or indirectly. A participant may also be a part of a group, such that the group has also a unique identity. Such a group may be incorporated in a super-group or divided into sub-groups. Thus a hierarchy of learner associations is manageable in the system. Moreover, members in a certain hierarchy may be reassigned to a different group in the course of an activity.

In a more complicated embodiment of the invention, a plurality of AUs are active in the learning activity. This may require typically the allotment of different individual learners or groups to one or more AUs.

Several AUs may share an AS, not only in the frame work of a specific AS but also in a broader sense. For example by having an AS database enabling AUs to duplicate, change and use existing ASs for their own instructional purposes. This may be accomplished due to the standardization of the AS formats while ASs are tagged by metadata characterizing each AS as a collaborative learning object (CLO).

1. A method for creating structured e-learning activities (AS) in which each stage (ASS) in a succession of stages implements a particular structure, wherein said activity structure is issued by an author who uses an authoring tool, and wherein at least two participants collaborate in each ASS by employing respective graphic user interfaces (GUIs), and wherein said ASS comprises at least one object selected from the group consisting of presentation objects, input objects, interaction objects and communication objects, and wherein the inputs from at least two GUI are sent to a database for subsequent presentation.

2. A method as in claim 1 and wherein said e-learning activity is asynchronous.

3. A structured system for collaborative active e-learning comprising:
at least two activity structure stages of said learning;
at least one presentation object associated with said activity structure;
an author interface for issuing and manipulating activity structures;
a participant interface for interacting with other participants and the author through said activity structure, and
a database for accepting inputted data of said participants and for facilitating inspection by said author.
